(19) United States
(12) Patent Application Publication
(10) Pub. No.: US 2016/0202394 A1
(43) Pub. Date: Jul. 14, 2016

(54) NANOSTRUCTURES FOR STRUCTURAL COLOURING

(71) Applicant: DANMARKS TEKNISKE UNIVERSITET, Lyngby (DK)

(72) Inventors: Jeppe Clausen, Copenhagen Ø (DK); Niels Asger Mortensen, Kgs. Lyngby (DK); Anders Kristensen, Frederiksberg C (DK); Emil Højlund-Nielsen, Copenhagen Ø (DK); Claus Jeppesen, Copenhagen Ø (DK); Alexander Bruun Christiansen, Copenhagen Ø (DK)

(73) Assignee: Danmarks Tekniske Universitet, Lyngby (DK)

(21) Appl. No.: 14/914,609

(22) PCT Filed: Sep. 2, 2014
(86) PCT No.: PCT/DK2014/050267

§ 371 Date: Feb. 25, 2016

(30) Foreign Application Priority Data
Sep. 2, 2013 (EP) 13182666.1
Jul. 1, 2014 (DK) PA 2014 70408

(51) Int. Cl. G02B 5/00; G02B 1/10; G02B 5/18

(52) U.S. Cl. CPC G02B 5/008; G02B 5/1861; G02B 1/10

(57) ABSTRACT

The invention relates to a nanostructured product with a structurally coloured surface. The nanostructured product includes a substrate with a nanostructured surface having nano-sized pillars or holes arranged in a periodic pattern and extending into or out from the substrate. The bottoms of the nano-sized holes or the tops of nano-sized pillars are provided with metal layers electrically isolated and distanced from a base surface of the nanostructured surface. A transparent or translucent protective layer covers the substrate and the metal layers.

### FIELD OF THE INVENTION

The invention relates to nanostructured surfaces, specifically to structural colouring by use of such surfaces.

### BACKGROUND OF THE INVENTION

It is known to decorate plastic objects by painting with a coloured painting material. The painting will adhere to the object after it has dried. Other methods for providing plastic objects with a coloured decoration exist. Normally such methods complicate the manufacturing process of the plastic objects since the process in addition to forming the plastic object includes various steps for applying the decoration.

Furthermore, painted products may complicate recycling of such products since the paint has to be removed before recycling the main object since the paint may otherwise add undesired colouring to the recycling material, e.g. a white colour of a main material will be polluted by black paint.

Accordingly, there is a need for other colouring processes for decorating objects which may not suffer from the above problems or which offer other advantages.

WO2013039454 discloses an optical arrangement which includes a substrate, and a plurality of spaced apart elongate nanostructures extending from a surface of the substrate, wherein each elongate nanostructure includes a metal layer on the end distal from the surface of the substrate. The present invention also relates to a method of forming the optical arrangement.

WO2012156049 discloses a two-dimensionally periodic, colour-filtering grating comprising a continuous, more particularly metallic, base layer having a high refractive index, said base layer defining a grating plane, and above the base layer a two-dimensionally regular pattern composed of individual, more particularly metallic, surface elements having a high refractive index, which each extend parallel to the grating plane and are each spaced apart from the base layer by an intermediate dielectric by a distance that is greater than the thickness of the base layer and of the surface elements, wherein the regular pattern has a periodicity of between 100 nm and 800 nm, preferably between 200 nm and 500 nm, in at least two directions running parallel to the grating plane.

### SUMMARY OF THE INVENTION

It would be advantageous to achieve improvements within methods for decorating polymer objects. In particular, it may be seen as an object of the present invention to provide a method that solves the above mentioned problems relating to colouring and/or recycling, or other problems, of the prior art.

To better address one or more of these concerns, in a first aspect of the invention a nanostructured product with a structurally coloured surface is presented that comprises
a substrate comprising a nanostructured surface, wherein the nanostructured surface comprises a base surface and nano-sized structural features arranged in a periodic pattern and extending into or out from the base surface,
metal islands provided on the nano-sized structural features so that each metal island is distanced from the base surface corresponding to a longitudinal dimension of the structural features,
a metal layer covering the base plane, and
a translucent protective layer covering the substrate and the metal islands, and wherein
the longitudinal dimension of the structural features is within a range from 30 to 80 nanometres, and wherein the metal islands and the metal layer are made from aluminium.

The combination of heights or depths within a range from 30 to 80 nanometres and aluminium islands and an aluminium layer on the base may be particularly efficient for producing a structurally coloured surface. That is, aluminium may be particularly efficient for avoiding undesired absorbance effects, e.g. due to surface plasmon polaritons, in the desired spectral range. Longitudinal dimensions of the structural features within a range from 30 to 80 nanometres, particularly within the range from 30 to 60 nanometres, may be particularly efficient for producing deep and sufficiently narrow absorption dips. Within this range, the spectral location of the absorption dips can be adjusted by varying the lateral dimension (width or diameter) of the nano-sized structural features.

It is noted that other embodiments may be envisaged wherein the metal layer on the base plane is omitted, and/or wherein the longitudinal dimension of the structural features is not within the range from 30 to 80 nanometres and/or wherein material for the metal islands and the metal layer is not aluminium, and/or wherein the nano-sized structural features may be arranged in a non-periodic pattern instead of a periodic pattern.

Therefore, a general embodiment which may be combined with other embodiments may be defined as a nanostructured product with a structurally coloured surface that comprises
a substrate comprising a nanostructured surface, wherein the nanostructured surface comprises a base surface and nano-sized structural features arranged in a periodic or non-periodic pattern and extending into or out from the base surface,
metal islands provided on the nano-sized structural features so that each metal island is distanced from the base surface corresponding to a longitudinal dimension of the structural features, and
a translucent or transparent protective layer covering the substrate and the metal islands.

Instead of a translucent protective layer a transparent protective layer may be used if diffusion of the reflected light is not desired.

Covering the substrate and the metal islands with a translucent protective layer includes products wherein a transparent layer is initially applied on the nanostructured surface. Therefore, covering the substrate and the metal islands with a translucent protective layer should not be construed as an exclusion for the possibility that other layers may layers med be present between the translucent protective layer and the nanostructured surface.

It is understood that the metal layer is located between the nano-sized structural features, i.e. so that the metal layer is in the form of a layer with holes corresponding the structural features.

It is understood that the metal islands are provided on the nano-sized structural features, i.e. deposited on the features, so that the metal islands are separated or distanced from the base surface corresponding to a longitudinal dimension (depth or height) of the structural features. Accordingly, each metal island has a distance to the base surface corresponding to the longitudinal dimension. Due to the longitudinal dimension of the structural features each metal island is separated from the metal layer.

The distance or separation between a metal island and the base, along the longitudinal direction of the nanostructures, may not be exactly equal to longitudinal dimension of the nanostructures due to imperfections in the production. For example, the metal islands may have an overhang from the nanostructures, and may extend down from the top of the nanostructures towards the base so that the separation is effectively decreased corresponding to the amount that the metal islands extend downwards. However, at least a portion of the metal islands, e.g. the centre portion of a metal island located on the centre portion of a rounded top of a nanostructure, has a separation from the base equal to or substantially equal to the longitudinal dimension of the structural features.

Advantageously, the protective layer may protect the nanostructured surface against external effects. Furthermore, the protective layer, particularly translucent layers, may improve the colour quality of the structural colours generated by the nanostructured surface.

Advantageously, due to the localized nature of the plasmonic resonances the nanostructured product according to this aspect may generate structural colours which are very angle independent.

Even though embodiments of the inventions have be described with focus on periodically arranged nano-sized structural features, it is contemplated that the nano-sized structural features may alternatively be placed in a random or non-periodic pattern for achieving similar or modified structural colour effects.

In an embodiment the protective layer comprises scattering particles and/or a structured surface for generating a translucent layer.

In an embodiment the nano-sized structural features are arranged in a periodic pattern, wherein the period of the pattern in at least one direction is within a range from 160 to 250 nm, such as within the range from 160-200 nm. Advantageously, by utilising a period within these ranges for one direction or two perpendicular directions, undesired diffraction on incident light may be avoided or limited.

In an embodiment a cross-sectional width of the nanostructures is within a range from 50 to 150 nm, e.g. from 50 to 110 nm. Advantageously, it may be possible to adjust the spectral location of absorbance dips by forming nanostructures with a particular width within this range.

In an embodiment the nanostructured product comprises a cluster of the nano-sized structural features which comprises first structural features characterised by a first dimensional parameter and second structural features characterised by a second dimensional parameter, wherein the first and second structural features are arranged intermingled in a periodic or non-period pattern. In an embodiment, the first and second dimensional parameters are cross-sectional widths of the nano-sized structural features.

In an embodiment the substrate is a polymer. For such polymer materials, the nanostructured product may be fabricated using injection moulding or hot embossing methods. Accordingly, an injection moulded product may be provided with a colour by virtue of the nanostructure surface so that colouring and shaping of the product is achieved in a single manufacturing step.

In an embodiment the nanostructured product comprises either
a first transparent protective layer covering the substrate and the metal islands, and,
a second translucent protective layer comprising scattering particles and/or a structured surface and covering the first protective layer, or
a first translucent protective layer comprising scattering particles and/or a structured surface and covering the substrate and the metal islands, and,
a second transparent protective layer covering the first protective layer. The sandwiched protective layer may be particularly efficient for generating diffused light. The sandwiched protective layer may contain any number of transparent and translucent layers arranged in alternating order.

In an embodiment the substrate contains material from a previously manufactured product according to the first aspect, wherein the material has been obtained by processing the entire previously manufactured product into the material. Since the nanostructured product may consist of only a single substrate material in addition to a very little percentage of metal and protective layer material, the nanostructured product may be suited for recycling. Thus, differently coloured recyclable objects are obtainable from the same original material. Accordingly, the substrate of the new nanostructured product may contain a percentage of recycled product material from a previously manufactured product. Thus, the recycled product material may contain both the substrate material, the metal of the islands, the metal layer covering the base, and material of the protective layer. The percentage of the recycled product material may between 10 and 100 percent.

A second aspect of the invention relates to a process for manufacturing the nanostructured product according to the first aspect, comprising
forming an object from a moulding material by moulding or embossing by use of a mould or embossing tool, wherein a surface of the mould or embossing tool is provided with the nanostructured surface comprising periodically arranged nano-sized structural features extending into or out from a base surface of the nanostructured surface, so that the forming creates the nanostructured surface, e.g. of the object which may be a plastic object,
providing the nano-sized structural features with a metal layer so that each surface is distanced from a base surface of the nanostructured surface corresponding to a longitudinal dimension of the structural features,
covering the substrate and the metal layers with a transparent or translucent protective layer.

In an embodiment the process for manufacturing the nanostructured product comprises
obtaining the moulding material from a previously moulded product configured according to the first aspect by processing the entire previously moulded product into the moulding material.

In summary the invention relates to a nanostructured product with a structurally coloured surface. The nanostructured product includes a substrate with a nanostructured surface having nano-sized pillars or holes arranged in a periodic pattern and extending into or out from the substrate. The bottoms of the nano-sized holes or the tops of nano-sized pillars are provided with metal layers electrically isolated and distanced from a base surface of the nanostructured surface. A transparent or translucent protective layer may cover the substrate and the metal layers.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates a nanostructured product 100 with a structurally coloured surface configured with pillar-like nano features 102,

FIG. 2 illustrates a nanostructured product 100 with a structurally coloured surface configured with hole-like nano features 102,

FIGS. 3A-3F show simulated reflectance as a function of wavelength within the spectral range 400-750 nanometre for nanostructured surfaces for different nano feature diameters and heights,

FIG. 4 shows simulated reflectance as a function of wavelength for different periods of the periodically arrange nano features,

FIG. 5 shows an embodiment where the nanostructured features have different sizes,

FIG. 6 shows how deposited metal islands 103 extend down along the nano-pillars and thereby reduces the distance between the metal layer 104 and the metal islands,

FIG. 7 shows absorbance dips 711, 712 due to interaction between aluminium islands and corresponding holes in the metal layer on the base surface,

FIG. 8 shows desired absorbance dips 811 due to interaction between aluminium islands (bonding) and undesired absorbance dips 812 due to surface plasmon polaritons, and

FIGS. 9A and 9B show undesired absorbance dips 812 along the curves for different periods due to surface plasmon polaritons in cases where the islands and base surface are made from aluminium and silver, respectively.

### DESCRIPTION OF AN EMBODIMENT

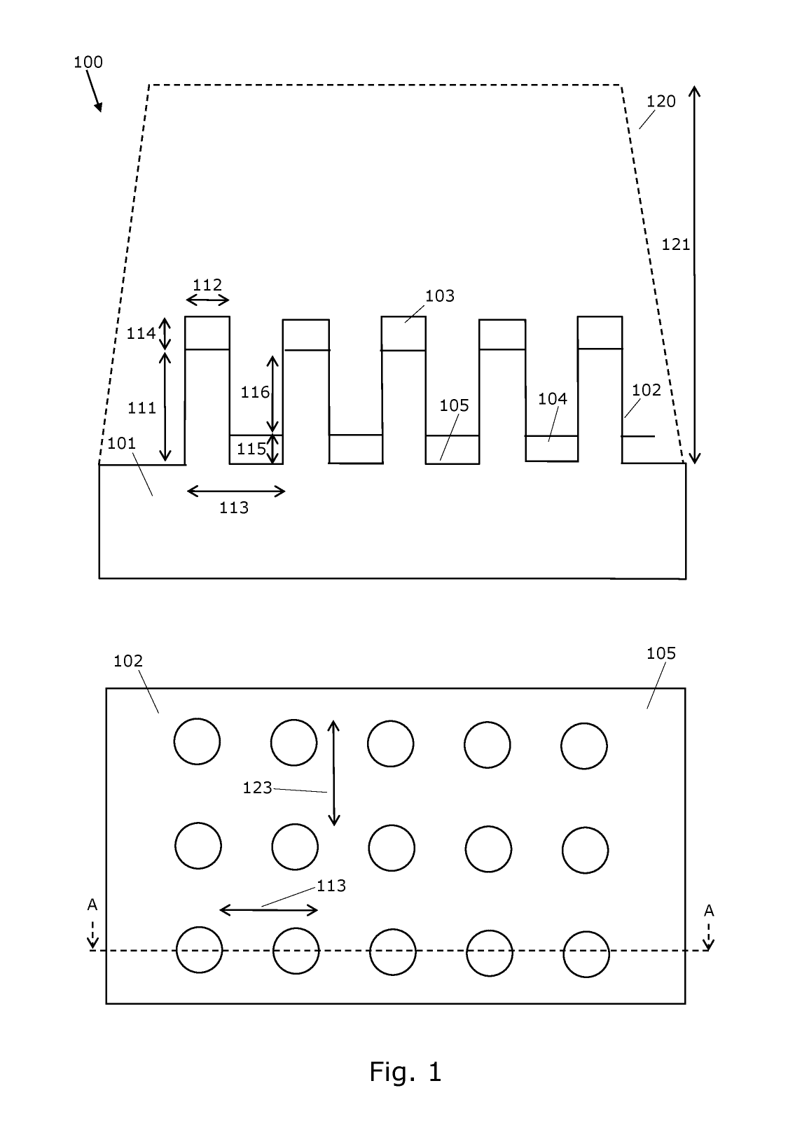

FIG. 1 principally illustrates a nanostructured product 100 with a structurally coloured surface. The nanostructured product 100 is illustrated in a top view (bottom image) and a cross-sectional view along line AA (upper image).

The product 100 includes a substrate 101 which includes a nanostructured surface having raised or depressed nanostructures 102, i.e. nano-sized structural features 102. Thus, the nanostructures 102 may be seen as elongate structures, e.g. pins, pillars, protrusions, depressions or holes, protruding out from or into the substrate. FIG. 1 illustrates raised structures. The elongate structures may have circular, square, hexagonal or other cross-sectional shapes in a plane perpendicular to the longitudinal direction of the elongate structures. The nanostructured surface defines a base plane 105, which may be a generally flat surface or a curved (e.g. double curved) surface, which the nanostructures 102 projects into or out from.

Structural colouring refers to colouring caused by optical effects due to the nanostructures instead of colouring caused by coloured pigments.

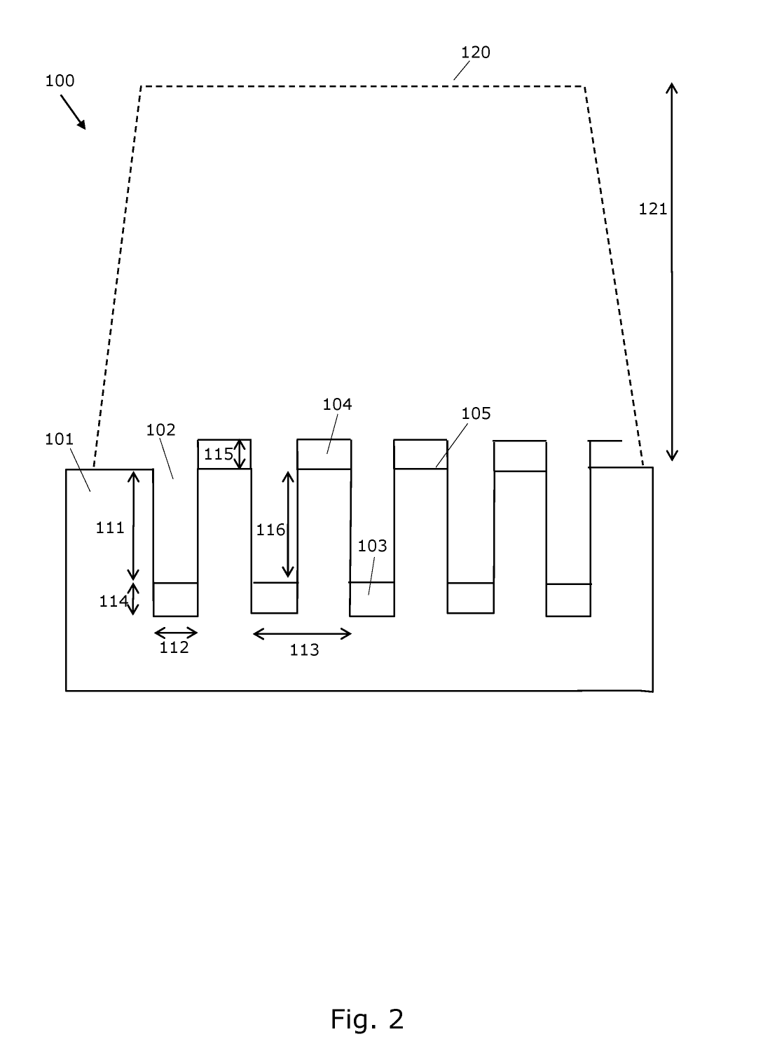

The nano-sized structural features are covered with metal layers or surfaces 103 so that each metal layer 103 is distanced from the base surface 105 corresponding to a longitudinal dimension 111 of the structural features 102. Thus, the metal layer 103 forms an isolated metal island on top of a protruding structure 102 or in the bottom of a depressed structure 102. FIG. 2 shows a cross-sectional view corresponding to the top view in FIG. 1 of an example wherein the nanostructures 102 projects into the substrate 101. Thus, in FIG. 2 the metal layers 102, i.e. metal islands, are defined as the metal portions in the bottom of the depressed, i.e. hole-shaped, nanostructures 102, the base surface 105 is defined as the upper surface from which the nanostructures 102 projects into the substrate 101, and the longitudinal dimension 111 is defined as distance between the upper base surface 105 and the bottom of the depressed structures 102.

In order to protect the nanostructured surface and the metal layers 103 against mechanical deformations and other environmental influences, e.g. fat from finger prints, the nanostructured surface including the metal layers 103 may be covered with a transparent or translucent protective layer 120. The protective layer 120 may have a thickness 121 relative to the base plane 105 in the range from approximately 1 micrometre to 1 millimetre and should be thick enough to avoid interference effects. The thickness of the protective layer 120 may be larger than 1 millimetre, e.g. if the substrate 1 is embedded in a transparent or translucent protective material. In a transparent material light is transmitted without being scattered. In a translucent material light is transmitted mainly as scattered light.

Translucent materials for the protective layer 120 may be preferred, since the colour effect from the nanostructured surface will be less dependent on the lighting conditions and the colour will appear more like normal colouring by pigments. On the other hand a translucent protective layer may reduce the best obtainable resolution of the nanostructured product 100.

Semi-crystalline polymeric materials scatter light on the grain boundaries between crystalline and amorphous regions (i.e. transparent regions) and may therefore be used for a translucent protective layer 120. Examples of semi-crystalline polymers are polyethylene and polypropylene. Co-polymers like ABS where different materials are collected in small domains is another example of translucent materials.

Amorphous polymers which are characterised in that the polymer chains are ordered in a random fashion are suitable for transparent protective layers 120. Examples of amorphous polymers are poly(methyl methacrylate), polystyrene and polycarbonate.

A transparent coating material can be made translucent by either mixing in some scattering particles or by creating a rough surface which will scatter the light, e.g. by sandblasting the protective layer which should have a scattering effect. As an example of mixing in particles in a translucent material aluminium oxide (Al2O3)-particles in the size range 100-1000 nm can be mixed into a transparent material of refractive index 1.5. Accordingly, the protective layer 120 may comprise scattering particles.

Accordingly, a translucent protective layer is a diffusor layer having the function of diffusing the reflected light from the nanostructured surface. The diffuser layer may be obtained by providing scattering particles to the layer and/or by structuring a surface of the layer.

Due to the possible periodic arrangement of the nano-sized structural features and the low period of the features, the nanostructured surface will act as a mirror such that the angle at which the light leaves the surface is the same as the incident angle (specular reflection). The consequence of this is that white light must be incident opposite from the observer in order for the surface to appear collared as intended. Due to varying lighting conditions in typical daily life situations, the surface will change appearance dependent on the viewing direction. The scattering properties of a translucent protective layer will minimize this effect and thereby mimic the properties of a normal ink or pigmented polymer better.

The protective layer may be configured as a sandwich layer comprising at least two layers, wherein one of the layers is transparent and another layer is translucent. For example, a scattering translucent layer may be applied first on the nanostructured surface followed by a transparent layer.

In general the nanostructured product may be configured so that a first transparent protective layer covers the substrate and the metal islands and so that a second translucent protective layer (i.e. a diffuser layer) covers the first protective layer, or vice versa. Clearly, more than one transparent layer and one translucent layer may be created to from a sandwiched protective layer with two or more transparent layers and two or more translucent layers.

In addition to offer structural protection, the protective layer also offers scattering or diffusion of the reflected light. Accordingly, the protective layer 120 may be seen as a diffuser layer.

The part of the base plane 105 which is located between the nanostructures 102 may be covered with a metal layer 104. The metal layer 104 may consist of the same metal as the metal layers 103 and may have approximately the same thickness as the metal layers 103. In the example with depressed nanostructures 102 the metal layer 104 is defined as the metal layer 104 located on top of the upper surface or base plane 105 (from which the nanostructures 102 projects into the substrate 101).

The heights 111 of the nanostructures 102 may be in the range from 20-250 nanometre depending e.g. on which metal is used for the metal layers 103. For aluminium layers 103 the heights 111 of the nanostructures 102 may be in the range from 30-80 nanometre. The heights 114 of the metal layers 103 in the longitudinal direction of the nanostructures 102 may be in the range from 5-70 nanometre. Thin metal layers may be preferred for ease fabrication of metal layers. However, a certain thickness of the metal is required for ensuring sufficient absorption. Accordingly, heights/thickness 114 of the metal layers 103 around 20 nanometre may be preferred. The cross-sectional width 112 of the nanostructures 102, e.g. a diameter of a circular shape or minimum/average transverse dimension of other shapes, may be in the range from 20-500 nanometre. The period 113, 123 of nanostructures 102 in a given direction may be in the range from 100-500 nanometre. A preferred period may be in the range from 150-250 nanometre, e.g. between 200-250 nanometre. Periods around 400-500 nanometre may generate undesired diffraction effects which will affect the structural colours of the nanostructure and may therefore be less preferred. Undesired diffraction effects may arise for even smaller periods like periods at 250 nanometre or less—however, pronounced undesired effects are believed to arise at periods above 400 nanometre. The nanostructures 102 may be arranged with different periods 113, 123 along different planar directions, so that the period 113 along a first planar direction is different from the period 123 along a second planar direction which is different from the first direction, e.g. perpendicular to the first direction. For example, the nanostructures 102 may be arranged in a hexagonal pattern with periods defined by a hexagonal pattern.

The heights 115 of the metal layers 104 in the longitudinal direction of the nanostructures 102 may, similarly to the heights 114, be in the range from 5-70 nanometre, for example around 20 nanometre.

A metal surface distance 116 is defined as the smallest distance between metal layers 103 (or metal islands 103) and the metal layer 104, i.e. a distance 116 between a lower portion of a metal island 103 and an upper portion of the metal layer 104 in the case of raised nanostructures 102, or a distance 116 between a lower portion of the metal layer 104 and an upper portion of a metal island 103 is the case of depressed nanostructures 102.

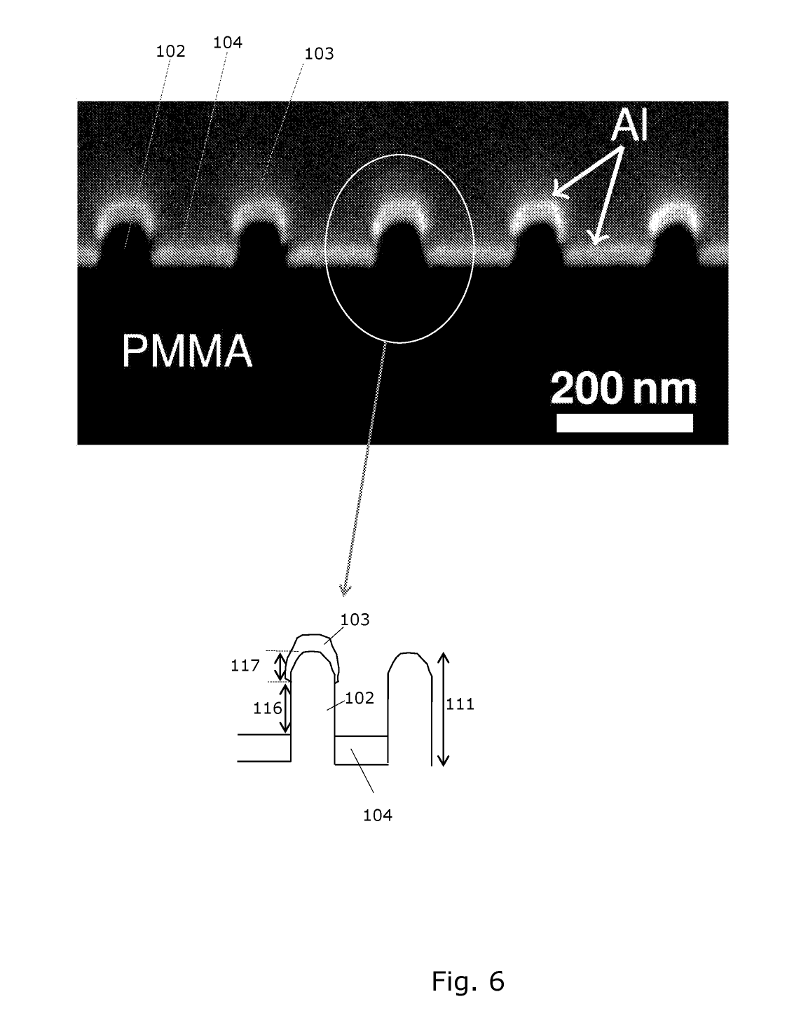

FIG. 6 shows a measurement image of a cross-sectional view of raised nanostructures 102, the upper metal surfaces 103 (metal islands 103) and the lower metal surface 104. The image shows that the top of the nanostructures 102 may be rounded and that the metal surfaces 103 may extend down from the top of the nanostructures 102 towards the lower metal surface 104. An illustrative sketch of the encircled portion in the image shows the metal surface distance 116 as the distance between the lower portion of a metal island 103 and an upper portion of the metal layer 104. Practically, it is difficult to achieve a production result wherein the metal islands 103 are located on top of the nanostructures. Therefore, in practice, partly due to the rounded tops of the nanostructures and partly due to the deposition-process of metal on the nanostructures, the metal islands 102 may extend a distance 117 down from the top of the nanostructures 102. The same applies to the metal surface 104 in the case of depressed nanostructured features 102 wherein overhangs of the metal surface may extend a distance 117 (not shown) down towards the bottom metal holes 103.

The metal surface distances 116 subtracted by the overhang distance 117 and the height 115 of the bottom metal layer 104 (or heights 114 of the bottom metal islands) corresponds to the heights 111 of the nanostructure 102.

Thus, whereas the heights 111 of the nanostructures 102 may be in the range from 30-80 nanometre, the metal surface distances 116 may be in the range from 10-50 nanometre, preferably in the range from 10-40 nanometre, possibly within the range from 10-20 nanometre.

Identically configured nanostructures 102 may be arranged over a surface of arbitrary area, e.g. over an area greater than four square millimetres, e.g. greater than one square centimetre or over even larger areas. Thus, nanostructures 102 configured with the same height 111, same width 112, same height 114 of metal layers 103 and/or same period 113, 123 may be distributed over an area of the above mentioned dimensions.

Alternatively, identically configured nanostructures 102 may be arranged in groups or clusters so that a first cluster includes nanostructures configured with substantially the same height 111, same width 112 and same period 113, 123, and a second cluster such as an adjacent cluster includes nanostructures configured so that at least one of the height 111, the width 112, and the period 113, 114 differs from the corresponding parameter(s) of the nanostructures 102 in the first cluster. Generally the thicknesses 114 of the metal layers 103 are the same for nanostructures 102 in one or more clusters. Thus, the nano-sized structural features in a cluster may be characterised by the same dimensional parameters (height 111, cross-sectional width 112, periods 113, 124, and metal layer thickness 114).

Alternatively, a cluster of the nano-sized structural features may be configured so that the cluster comprises first structural features characterised by a first dimensional parameter and second structural features characterised by a second dimensional parameter, wherein the first and second structural features are arranged intermingled in a periodic or non-period pattern. The first and the second dimensional parameter may be a height 111, a cross-sectional width 112, or a period 113, 124. For example, the first and second dimensional parameters may be cross-sectional widths 112 so that a cluster of arbitrary size comprises first structural features with a first cross-sectional width 112 and second structural features with a second cross-sectional width 112.

In general it is possible to have first, second, third or more structural features characterised by different first, second, third or more dimensional parameters. Thus, the intermingled or superimposed nanofeatures may have two or more different sizes, e.g. different widths.

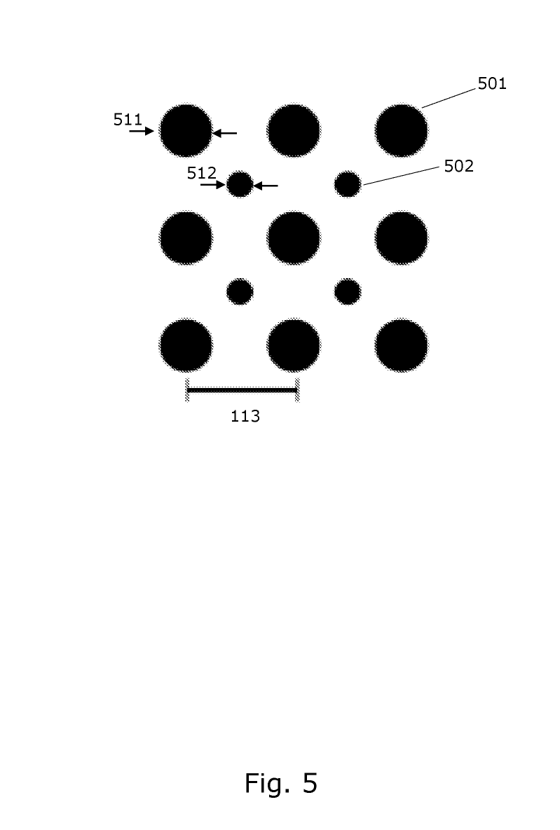

FIG. 5 shows an example of a cluster or a subset of a cluster comprising first structural features 501 characterised by a first cross-sectional width 511 and second structural features 502 characterised by a second cross-sectional width 512, wherein the first and second structural features are arranged intermingled in periodic patterns, and wherein the first and second structural features are arranged with the same periods 113. Alternatively, both the first and second structural features, or the first but not the second structural features may be arranged in a random or non-periodic pattern.

Advantageously, the combination of structural features having different dimensional sizes, e.g. different diameters 112 may be used for obtaining a specific reflection spectrum for obtaining a specific structural colour.

By use of different cross-sectional widths 511, 512 it is possible to create more than one resonance dip in the reflectance spectrum so that it may be possible to fabricate more colours compared to nanostructured surfaces with only one cross-sectional width.

Due to tolerances in fabrication and limitations in measurement accuracy, it is understood that a reference to a given nanometre or micrometre dimension 111, 112, 113, 114, 121, 123 includes such tolerances and accuracies. Thus, reference to a given dimension may be understood to include deviations from that dimension in the range from 1 to 50 percent.

The nanostructures 102 are arranged in a periodic pattern, i.e. in a pattern wherein the periods 123, 114 are constant or substantially constant over a given area, e.g. an area of a cluster.

The structural colour effect and, thereby, the generation of a particular colour from the nanostructured surface is due to plasmonic resonances in the metal layers 103. That is, metal layers 103 having certain dimensions and geometries—as defined by the dimensions of the nanostructures 102—are excitable into resonant vibrations by incident light of certain wavelengths. The light with a spectral range which excite resonant vibrations are absorbed to a certain degree by the metal layers 103. Accordingly, by configuring nanostructures with certain dimensions and geometries it is possible to absorb a certain spectral range on the incident light, so that the non-absorbed spectral range is reflected or scattered from the nanostructured surface. Since the intensity of a part of the spectral range of the reflected light is significantly reduced due to the absorbance the reflected light achieves a particular colour.

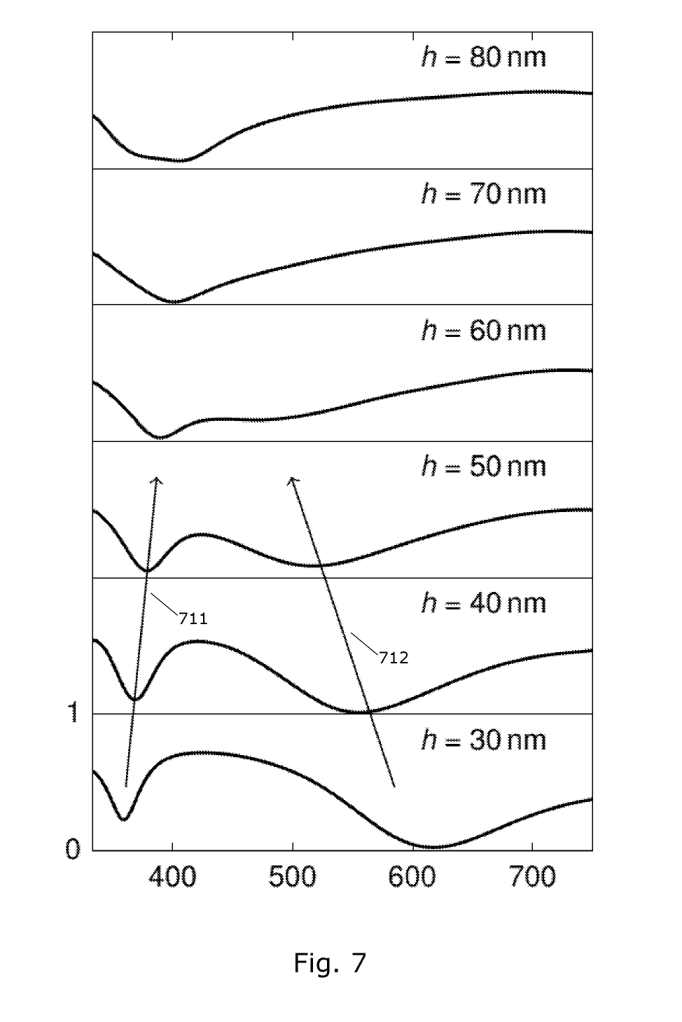

It is believed that the plasmonic resonances is not only due to the metal layers (metal islands) 103 but that certain effects of the plasmonic resonances is caused by the interaction of the metal islands 103 and the holes in the metal layer 104. This interaction can be explained by considering the metal islands 103 and the holes in the metal layer 104 as elements in the nanostructured surface. The metal islands and the holes possesses resonances of their own. The lowest energy resonances for the islands and the holes are given according to their dipolar resonances where the electrons in the hole oscillates as one dipole and where the electrons in the hole oscillates as another dipole. The positions of these resonances for similar sized holes and disks lie very close terms of energy (or wavelength). When bringing an island and a hole close to each other, e.g. by separating them according to the longitudinal dimension of the nano-sized structural features, the two dipoles starts to interact and instead of having two separate dipoles, the island and hole acts as one single structure with two new modes (a bonding mode and an anti-bonding mode). The two modes have different energies and therefore different resonance frequencies. The two dips in the reflectance spectra corresponding to the resonance frequencies (determined by the coupling between the two dipoles) is shown in FIG. 7.

FIG. 7 shows reflectance spectra for nanostructured surfaces wherein the longitudinal dimension 111 is varied from 30-80 and wherein the cross-sectional width 112 is 80 nm and the period 113,123 is 200 nm. The thickness dimensions of the islands 103 and the metal surface 104 is around 20 nm and the nanostructured surface is embedded in a translucent material with a refractive index of 1.5. The material of the islands 103 and the metal surface 104 is aluminium. The two modes are seen as dips in the spectra. The coupling and thereby the energy splitting decrease with increasing longitudinal dimension 111 leading to a shift of the resonances towards the natural resonances of the disk and hole arrays.

FIG. 7 shows that the lower resonance wavelength of the anti-bonding mode 711 and the higher resonance wavelength of the bonding mode 712 approaches and merges as the longitudinal dimension becomes larger than 60 nm. Other simulation results show that the two resonance frequencies merge when the longitudinal dimension becomes close to 80 nm.

In conclusion, low values of the longitudinal dimension 111 lead to large coupling and large energy splitting, whereas higher values of the longitudinal dimension 111 lead to lower coupling and less energy splitting. As the longitudinal dimension 111 become higher than 60-70 nm the coupling becomes weaker and the hybrid modes of the island 103 and the hole merges so that the system behaves more like a separate island and hole again. Accordingly, the results suggests that the longitudinal dimension 111 should be between 30 and 80 nm, possibly between 30 and 60 nm.

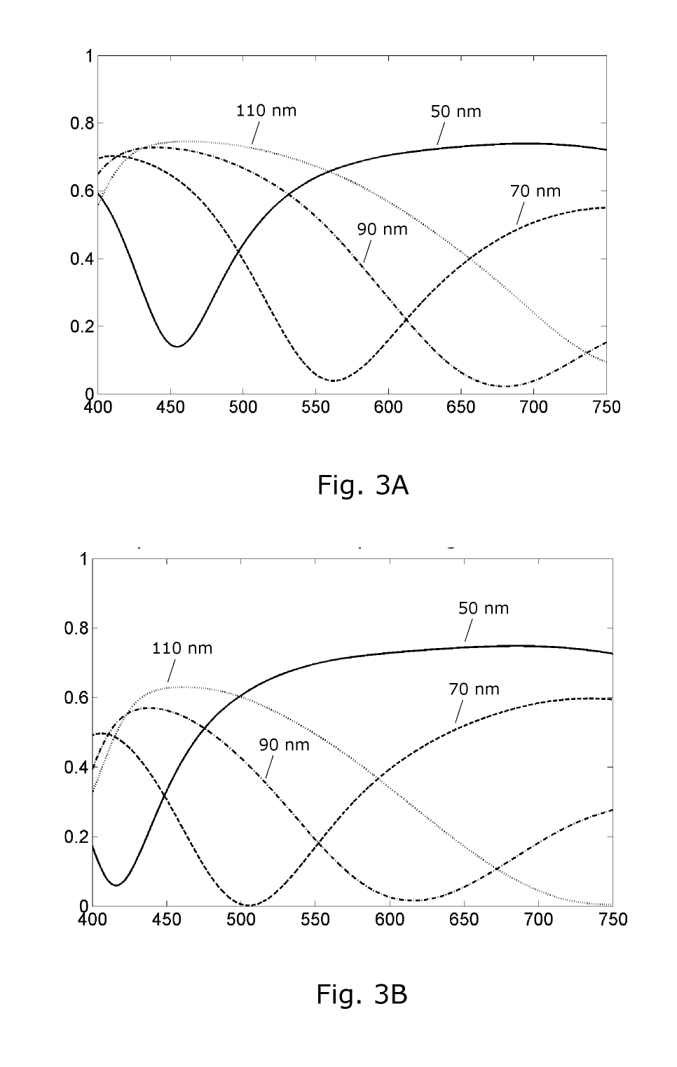

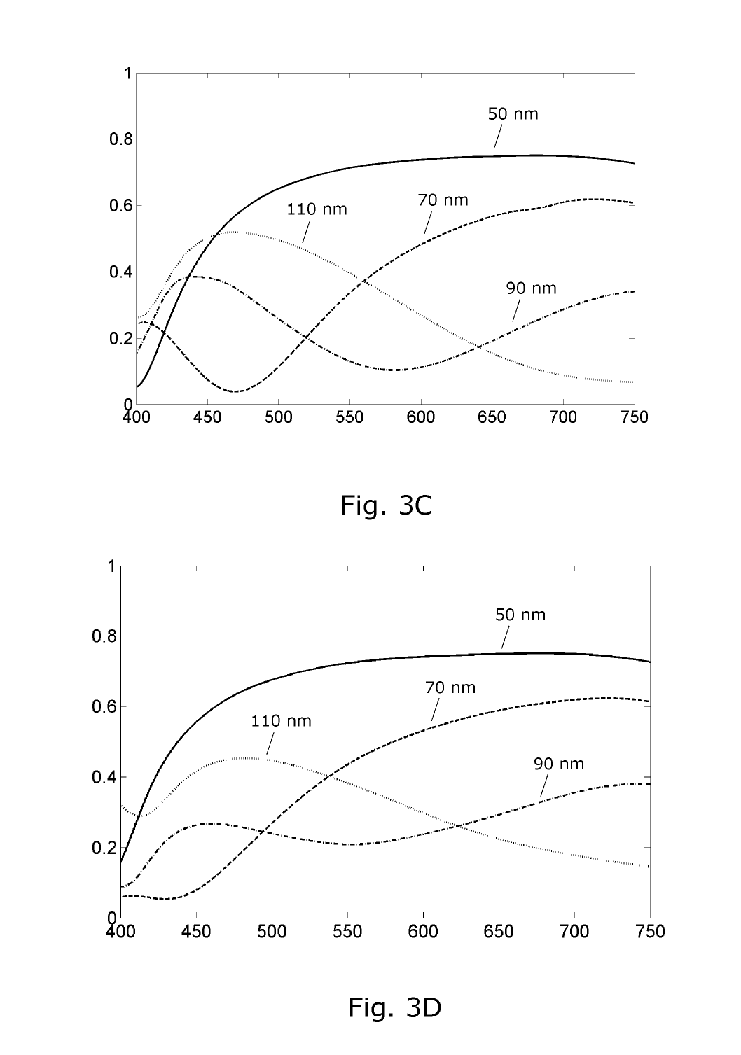

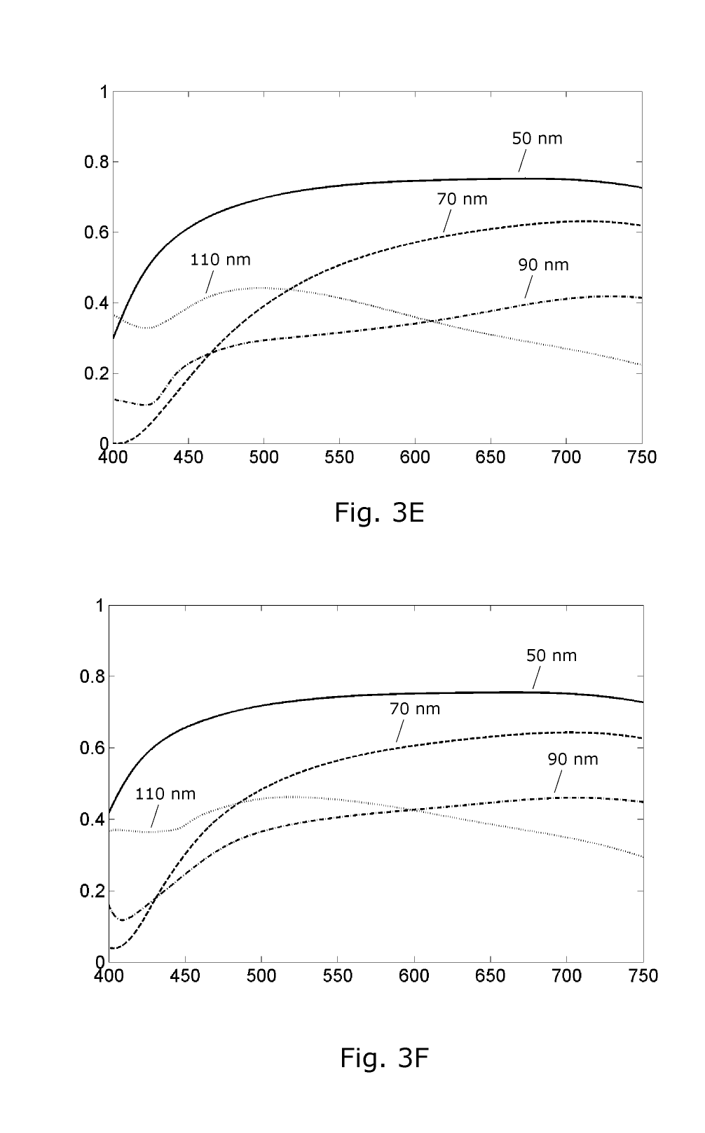

In an embodiment of the invention the bonding mode 712 is utilised for achieving the deep tuneable absorption dips in the spectra and therefore also for the production of bright colours. By comparing e.g. FIG. 3A (see description below) with the lower spectra in FIG. 7 it is seen that the absorption dips in FIG. 3A, as well as the absorption dips in FIGS. 3B-F, are caused by the bonding mode due to the coupling between the metal islands 103 and the holes in the metal layer 104.

Thus, the metal layer 104 may have an amplifying effect or an efficiency improving effect on the absorption of incident light. The metal layer 104 may further improve reflection of the spectral fraction of light which lies outside the absorption dips.

Accordingly, one or more of the parameters, height 111, metal layer height 114, cross-sectional width 112 and period 113,123 may be varied in order to obtain absorption of certain spectral ranges.

FIGS. 3A-F show simulated reflectance as a function of wavelength within the spectral range 400-750 nanometre for nanostructured surfaces. The period 113, 123 is 200 nanometre, the metal layer heights 114 and 115 is 20 nanometre, the material of the metal layers is aluminium, the refractive index of the protective layer 120 is 1.50 and the refractive index of the substrate is 1.52 for all simulations in FIG. 3A-F. The cross-sectional width 112 is varied from 50 to 110 nanometre in each figure in FIGS. 3A-F as shown by the labels of each graph. The height 111 is varied over FIGS. 3A-F so that FIG. 3A shows results for height 111=30 nanometre, FIG. 3B shows results for height 111=40 nanometre, FIG. 3C shows results for height 111=50 nanometre, FIG. 3D shows results for height 111=60 nanometre, FIG. 3E shows results for height 111=70 nanometre, and FIG. 3F shows results for height 111=80 nanometre.

Although FIGS. 3A-F only shows results for widths 112 in the interval 50-110 nm, it is expected that widths up to 150 nm may also provide useable results.

FIGS. 3A-F show that it is possible to obtain absorption in different spectral ranges by configuring the nanostructured surfaces with different diameters of the nanostructures 102.

FIG. 3A shows that a first colour can be generated by a nanostructured surface with nanostructures having a width of 50 nanometre, a second colour can be generated by a nanostructured surface with nanostructures having a width of 70 nanometre, a third colour can be generated by a nanostructured surface with nanostructures having a width of 90 nanometre and a fourth colour can be generated by a nanostructured surface with nanostructures having a width of 110 nanometre.

The reflectance curves in FIGS. 3E-F show that variations in the width of the nanostructures 102 generate less significant variation in absorption in different spectral ranges as compared to reflectance curves in FIGS. 3A-D. Thus, the nanostructured surfaces in FIGS. 3E-F may be less suited for generating different colours.

Thus, FIGS. 3A-F and FIG. 7 show that nanostructures with aluminium surfaces 103 wherein the longitudinal dimension 111 (height or depth) of the structural features 102 is within the range from 30 to 80 nanometres may be suited for generating structural colours, but that longitudinal dimensions in the range from 30 to 60 nanometres may be particularly suited for generating structural colours.

Advantageously, the relatively short longitudinal dimensions in the range from 30 to 80 nanometres may be more robust (e.g. less prone to break) than higher or deeper nanostructures 102. A further advantage of the relatively short longitudinal dimensions is that short structures may be easier to produce using injection moulding or hot embossing manufacturing processes.

Compared to metal layers 103 of other materials, e.g. silver or gold, it appears that metal layers 103 of aluminium are effective for generating structural colours in a relative short range of longitudinal dimensions 111. Advantageously, aluminium is cheaper than gold or silver—this may be particularly advantageous for large scale production of products using e.g. injection moulding.

As explained, other dimensional parameters than cross-sectional width 112 of nanostructures 102 may be varied for obtaining different structural colours.

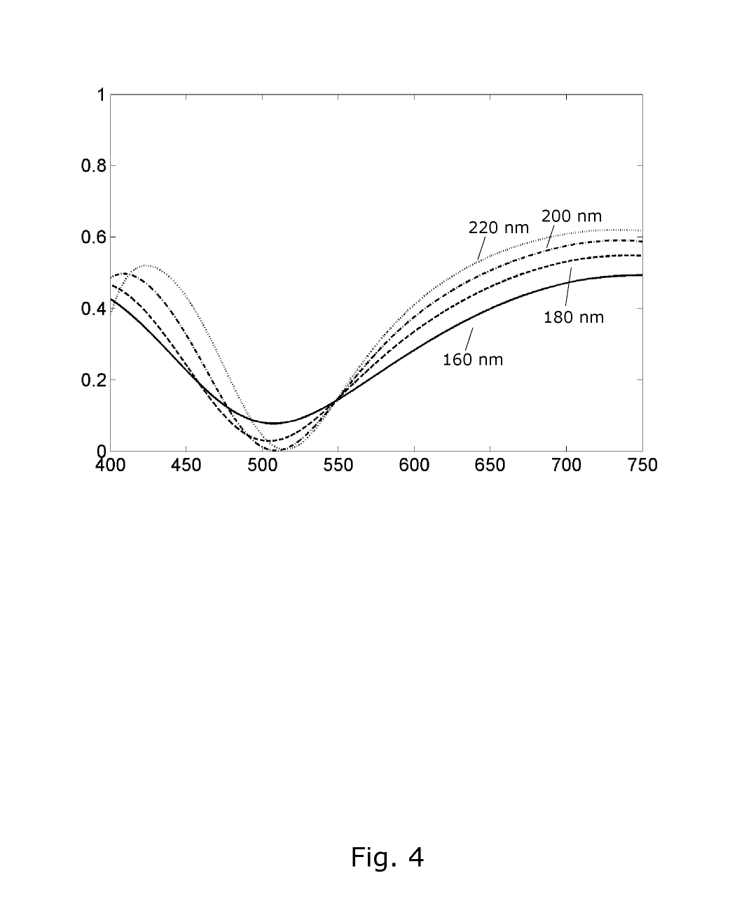

FIG. 4 shows simulated reflectance as a function of wavelength within the spectral range 400-750 nanometre for nanostructured surfaces wherein the period 113,123 in two orthogonal directions (same period in both directions) is varied.

The fixed parameters in FIG. 4 are: structure height 111=40 nanometre, structure diameter 112=70 nanometre, height of aluminium layer 103=20 nanometre, refractive index of substrate=1.52, and refractive index of protective layer=1.50. Although a pronounced dip in reflectance is generated close to 500 nanometre, the spectral shift of the dip is relatively small. This suggests that variations in width 112 are more efficient for generating different structural colours than variations in the period of the nano-sized structural features.

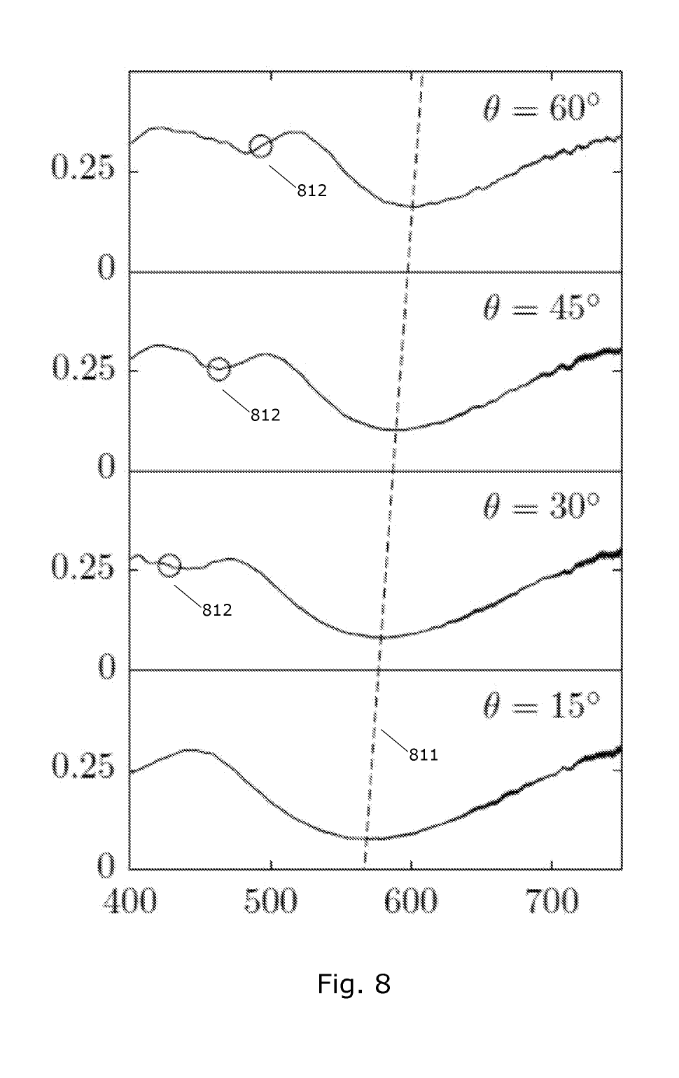

FIG. 8 shows reflectance as a function of wavelength for different angles θ of incidence of the incoming light (The nanostructured surface is characterised by longitudinal dimension 111=58 nm, width 112=86 nm, period=200 nm and layers 103, 104 are made of aluminium). The reflection dip along the dotted line 811 corresponds to the resonance frequency of the bonding mode 712. A slight angle-dependency on the absorbed wavelengths and, thereby, the reflected spectrum, is observed. FIG. 8 further shows reflections dips indicated by circles 812. These reflection dips are due to surface plasmon polaritons. Surface plasmon polaritons (SPPs) are surface waves which are localized to the surface/interface between a dielectric material (e.g. air or polymer) and a plasma (e.g. metal). In order to couple light into such waves certain conditions must be fulfilled. There must be a match in both energy and horizontal momentum. This can be fulfilled when a grating is present on the metal surface. This is the case for the nanostructured surface according to embodiments of the invention. When incident light couples to SPPs there typically occurs a dip in the reflectance spectrum, since energy is channelled into the surface wave and absorbed in the metal. The condition for coupling to SPPs depends on the angle of incidence and the material properties of the involved materials including the metal.

The reflectance dips 812 are located sufficiently far from the reflectance dip 811 so that the surface plasmon polaritons only weakly affects the reflection dip 811.

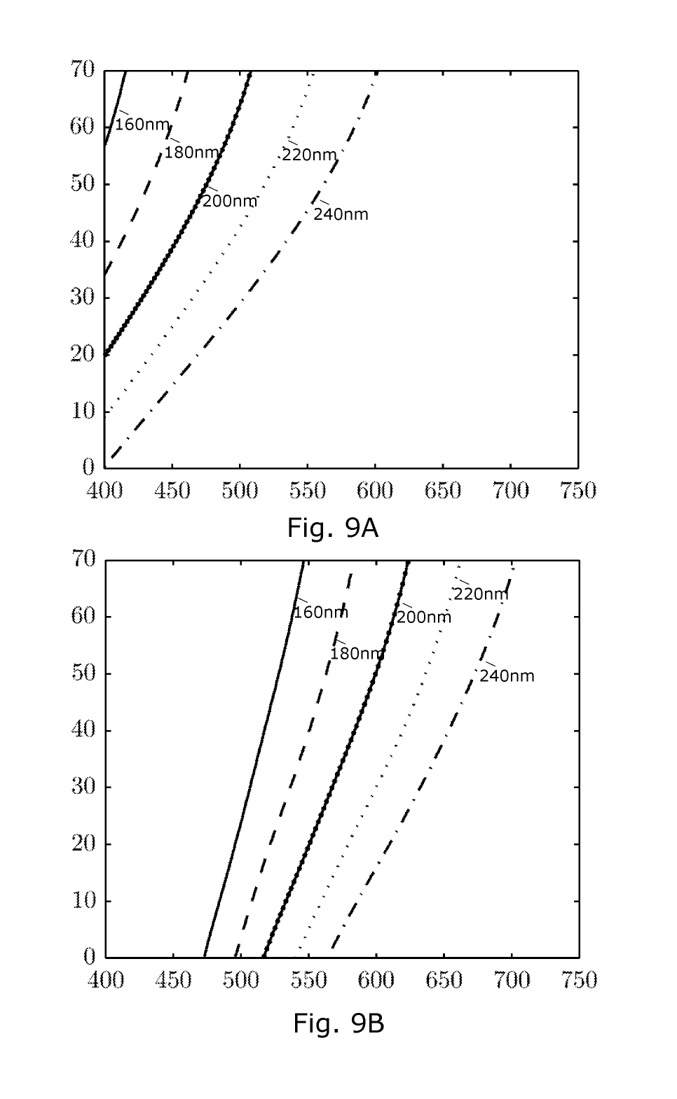

FIG. 9A and FIG. 9B show locations of the reflectance dips 812 due to surface plasmon polaritons for different periods 113, 123 in the range 160-240 nm as a function of wavelength (along the abscissa) and angles of incidence (along the ordinate). In FIG. 9A, the material of the layers 103, 104 is aluminium. In FIG. 9B the material of the layers 103, 104 is silver.

FIG. 9B shows that the reflectance dips 812 are located in the visible spectrum and therefore affect the reflection dips 811 in an undesired way, e.g. by increasing angle dependency. On the other hand, FIG. 9A shows that the reflectance dips 812 are located at lower wavelengths, particularly for the lower periods 113, 123. Accordingly, in order to reduce the influence of surface plasmon polaritons on the desired spectral properties of the nanostructured surface, there may be an advantage of using aluminium for the metal layers 103, 104.

FIG. 9A further suggests that the periods 113, 123 (in one or two directions) should be less than 240 nm preferably less than 200 nm, e.g. between 160 and 200 nm. A further advantage of having periods lower than 240 nm, preferably lower than 200 nm is that generation of first or higher order diffraction is reduced. Such diffraction effects are undesired as they might disturb the colour in a certain angle.

Generally, the nanostructured product 100 may be a film, a foil, a part of an end-product or an end-product. Specific examples of a nanostructured product 100 comprise interior parts for cars, toys, household appliances, etc. For example, a surface of an interior part for cars may be provided with structurally coloured decorations, and a toy may be provided with a decoration by forming a nanostructured surface in a surface of the toy.

Thus, in an embodiment the nanostructured product is in the form of a film or foil configured to be connected to another object, e.g. via an adhesive layer. According to this embodiment the film-substrate is embodied by the substrate 101. The nanostructured surface including nano-features 102, metal layers 103 and optionally a protective layer 120 may be provided on a front face of the film-substrate. A back face of the film may be configured, e.g. with an adhesive layer, for enabling connection to an object.

The substrate may be a polymer such as plastic, ABS plastic, a glass material, or other dielectric material that could be nanostructured. Accordingly, the entire product 100 may be made from the same substrate material where only metal layers 103 on top of nano-features 102, possibly a metal layer 104 on the base plane 105 and possibly a transparent or translucent protective layer are added. Thus, it may be possible to decorate or colour a product 100 with graphics, text or surface colouring by use of the nanostructured surface and metal layers 103 without a need to print a decoration on the object using pigmented paint. The substrate 101 may be opaque, transparent, semi-transparent, or translucent. The product 100 may be formed by moulding, e.g. injection moulding, by use of a mould, wherein a surface of the mould is provided with a nanostructured surface, so that the moulding creates the nanostructured surface of the plastic object. Alternatively, the product 100 may be formed by hot embossing where an embossing tool is provided with a nanostructured surface so that the embossing creates the nanostructured surface of the plastic object. The process for manufacturing the product 100 further comprises covering the nanostructured surface of the plastic object with isolated metal layers 103 and possibly a bottom metal layer 104 so that metal layers 103 generates absorption of light in subranges of the visible spectral range from approximately 400 to 750 nanometre. The visible spectral range may be defined differently, e.g. as the range from 300-700 nanometre.

Advantageously, the product—which may be a single unit and containing different structures such a millimetre sized structures and the nanostructured surface(s)—may be produced in a single step, e.g. by injection moulding wherein the mould is configured to produce both the millimetre sized structures and the nanostructured surface(s). The millimetre sized structures could be design for functional features of the product. Thus, the product—including millimetre sized structures and the substrate 101—may consist of the same single plastic material plus the metal layer 105 and possibly the protective layer.

The mould or embossing tool may be made using electroplating to make a metal mould from a silicon master or other master. Typically nickel or an alloy hereof is used in the electroplating process to apply a metal layer (e.g. 200 micrometre thick) on the nanostructured silicon master so that a metal layer with a negative pattern of the positive pattern on the silicon master is formed.

The process of creating the metal layers 103 on top of the nanostructured features 103 may be performed using e.g. physical vapour deposition (PVD), e.g. electron beam PVD wherein an electron beam is used to evaporate the metal from solid/liquid phase to gas phase. The gas condenses as a thin film on the nanostructured surface and thus covers the nanostructured surface with a metal layer. In this process both the top surfaces of the nanostructures 102 and the base plane 105 is provided with a metal layer. Due to the steep edges of the nanostructures 102, metal is substantially only provided on the top surfaces of the nanostructures 102 and on the base plane 105 so that the metal layers 103 becomes isolated from the bottom metal layer 105.

Since the nanostructured product substantially only contains the material of the substrate, the product 100 is suited for being recycled. The volume content of metal originating from the metal layers 103, 104 is very small compared to the volume of the substrate. The possible protective layer 120 also constitutes a relative small fraction of the substrate material. Furthermore, the material of the protective layer may be of a type which can be mixed with the substrate material without lowering the properties of the substrate material, i.e. properties which are important for making the nanostructured surface.

Thus, even though products 100 having different structural colours are recycled into a moulding material for forming new nanostructured products, the new nanostructured products can be configured to attain colours independently of the previous colours of the recycled products 100.

Thus, the process of manufacturing a nanostructured product 100 may further include the step of obtaining the moulding material from a previously moulded product according by processing the entire previously moulded product into the moulding material.

Accordingly, the substrate of a new nanostructured product (obtained from recycled material) may contain or consist of material from a previously moulded product, wherein the material has been obtained by processing the entire previously moulded product into the material, i.e. without removing material from the previously moulded product. The recycling may be performed so that the new nanostructured product only contains, or substantially only contains substrate material from recycled nanostructured products. However, the recycling may also be performed so that the new nanostructured product only consists of a certain percentage, e.g. 50 percent, of recycled material from old nanostructured products, whereas the reminder of the material is new.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A nanostructured product with a structurally coloured surface, comprising:
a substrate comprising a nanostructured surface, wherein the nanostructured surface comprises a base plane and nano-sized structural features arranged in a periodic pattern and extending into or out from the base plane,
metal islands provided on the nano-sized structural features so that each metal island is distanced from the base plane corresponding to a longitudinal dimension of the structural features,
a metal layer covering the base plane, and
a transparent or translucent protective layer covering the substrate and the metal islands, wherein
the longitudinal dimension of the structural features is within a range from 30 to 80 nanometres, and wherein the metal islands and the metal layer are made from aluminium.

2-11. (canceled)

12. The nanostructured product according to claim 1, wherein the nano-sized structural features are arranged in a periodic pattern, and wherein the period of the pattern in at least one direction is within a range from 160 to 250 nm or within the range from 160-20 nm.

13. The nanostructured product according to claim 1, wherein a cross-sectional width of the nanostructures is within a range from 50 to 150 nm.

14. The nanostructured product according to claim 1, wherein a cluster of the nano-sized structural features comprises first structural features comprising a first dimensional parameter and second structural features comprising a second dimensional parameter, wherein the first and second structural features are arranged intermingled in a periodic pattern.

15. The nanostructured product according to claim 14, wherein the first and second dimensional parameters are cross-sectional widths of the nano-sized structural features.

16. The nanostructured product according to claim 1, wherein the substrate is a polymer.

17. The nanostructured product according to claim 1, wherein the protective layer comprises scattering particles and/or a structured surface.

18. The nanostructured product according to claim 1, comprising either:
a first transparent protective layer covering the substrate and the metal islands, and,
a second translucent protective layer comprising scattering particles and/or a structured surface and covering the first protective layer, or
a first translucent protective layer comprising scattering particles and/or a structured surface and covering the substrate and the metal islands, and
a second transparent protective layer covering the first protective layer.

19. The nanostructured product according to claim 1, wherein the substrate contains material from a previously manufactured product that comprises:
a substrate comprising a nanostructured surface, wherein the nanostructured surface comprises a base plane and nano-sized structural features arranged in a periodic pattern and extending into or out from the base plane,
metal islands provided on the nano-sized structural features so that each metal island is distanced from the base plane corresponding to a longitudinal dimension of the structural features,
a metal layer covering the base plane, and
a transparent or translucent protective layer covering the substrate and the metal islands, wherein the longitudinal dimension of the structural features is within a range from 30 to 80 nanometres, wherein the metal islands and the metal layer are made from aluminum, and
wherein the material has been obtained by processing the entire previously manufactured product into the material.

20. A process for manufacturing the nanostructured product according to claim 1, comprising:
forming an object from a moulding material by moulding or embossing by use of a mould or embossing tool, wherein a surface of the mould or embossing tool is provided with the nanostructured surface comprising periodically arranged nano-sized structural features extending into or out from a base plane of the nanostructured surface, so that the forming creates the nanostructured surface,
providing the nano-sized structural features with aluminium islands so that island is distanced from the base plane of the nanostructured surface corresponding to a longitudinal dimension of the structural features, wherein the longitudinal dimension is within a range from 30 to 80 nanometres,
covering the base plane with an aluminium layer, and
covering the substrate and the metal islands with a transparent or translucent protective layer.

21. A process for manufacturing the nanostructured product according to claim 20, further comprising
obtaining the moulding material from a previously moulded product that comprises:
a substrate comprising a nanostructured surface, wherein the nanostructured surface comprises a base plane and nano-sized structural features arranged in a periodic pattern and extending into or out from the base plane,
metal islands provided on the nano-sized structural features so that each metal island is distanced from the base plane corresponding to a longitudinal dimension of the structural features,
a metal layer covering the base plane, and
a transparent or translucent protective layer covering the substrate and the metal islands, wherein the longitudinal dimension of the structural features is within a range from 30 to 80 nanometres, wherein the metal islands and the metal layer are made from wherein the entire nanostructured product is processed into the moulding material.
